(19) United States
(12) Patent Application Publication
(10) Pub. No.: US 2021/0300508 A1
(43) Pub. Date: Sep. 30, 2021

(54) DREDGE STABILIZATION AND MOVEMENT SYSTEM

(71) Applicant: CASHMAN DREDGING AND MARINE CONTRACTING, CO., LLC, Quincy, MA (US)

(72) Inventors: Aiden Horan, Waltham, MA (US); Jay Cashman, Quincy, MA (US)

(21) Appl. No.: 17/213,701

(22) Filed: Mar. 26, 2021

Related U.S. Application Data
(60) Provisional application No. 63/000,661, filed on Mar. 27, 2020.

(51) Int. Cl. B63B 79/40; E02F 5/00; B63B 21/50; G05D 1/02; G05D 1/00; B63B 35/44

(52) U.S. Cl. CPC B63B 79/40; E02F 5/006; B63B 35/44; G05D 1/0206; G05D 1/0011; B63B 21/50

(57) ABSTRACT

A marine positioning system can have a floating platform, an external vessel, a positioning module, and a control module. The external vessel can be configured to selectively tow and maintain the floating platforming in a preselected position. The external vessel can have a propulsion unit. The propulsion unit can be configured to propel the floating platform in a preselected direction between 0 and 360 degrees. The control module can be in communication with the propulsion unit and the positioning module. The control module can be configured to receive the location data from the positioning module. Also, the control module can be configured to determine if the floating platform is in the preselecting position. In addition, the control module can be configured to generate instructions including the preselected direction that the floating platform needs to travel to be positioned in the preselected position.

### CROSS-REFERENCE TO RELATED APPLICATIONS

This application claims the benefit of U.S. Provisional Application Ser. No. 63/000,661, filed on Mar. 27, 2020. The entire disclosure of the above application is incorporated herein by reference.

### FIELD

The present disclosure relates to dredging vessels, more particularly, to the positioning and maneuverability of dredging vessels.

### INTRODUCTION

This section provides background information related to the present disclosure which is not necessarily prior art.

Dredging vessels, hereafter referred to as “dredges,” are used to remove material from the floor or bottom of a body of water. The areas in need of dredging require the dredges to be accurately positioned on the surface of the water to remove the material directly below. Modern dredges are generally positioned and secured in place using anchors or spuds. Spuds are vertical legs extending from the dredge to the seafloor. These traditional methods are limited in depth capacity and efficiency of moving between dredging locations. One particular method for positioning dredges is described in U.S. Pat. No. 8,844,459 to Robert Perez. This method includes two separate elements which are removably attached. The tugboat includes means at the bow to removably attach to the barge, and means to control the means for maneuvering the barge from the tugboat. Undesirably, such methods lack the ability to efficiently maintain a position of the dredge on the surface of the body of water as the system was not designed for the marine construction field. The ability to provide movement and position maintenance for dredges enhances the opportunity to remain in a desired position at a dredging location when dredges begin to drift.

There is a continuing need for a system and method for positioning dredges in deeper waters. Desirably, the system and method would allow the dredge to be actively maintained in a preselected position.

### SUMMARY

In concordance with the instant disclosure, systems and methods for positioning dredges in deeper waters, and which allow the dredge to be actively maintained in a preselected position, have been surprisingly discovered.

In certain embodiments, marine positioning systems are provided that can include a floating platform, an external vessel, a positioning module, and a control module. The external vessel can be reversibly coupled to the floating platform and configured to position the floating platform in a preselected position. The external vessel can have a propulsion unit configured to propel the floating platform in a preselected direction between 0 and 360 degrees. The control module can be in communication with the propulsion unit and the positioning module. The control module can be configured to receive the location data from the positioning module. Also, the control module can be configured to determine if the floating platform is in the preselecting position. In addition, the control module can be configured to generate instructions including the preselected direction that the floating platform needs to travel to be positioned in the preselected position.

In certain embodiments, ways of using such marine positioning systems are provided. The positioning module of the marine positioning system can generate the location data of one of the floating platform, external vessel, and both the floating platform and the external vessel. The control module can receive the location data. The control module can determine if the floating platform is in the preselected position and can generate instructions that include the preselected direction that the floating platform needs to travel to be positioned in the preselected position.

In an exemplary embodiment, a dredge stabilization and movement system can include a dredge attached to a plurality of external vessels. The plurality of external positioning vessels can include a first external positioning vessel and a second external positioning vessel. As a non-limiting example, each external positioning vessel can be a tugboat. A skilled artisan can select other suitable vessels for the external positioning vessel, as desired. The number and location of vessels can vary and should not be limited to that which is shown in the figures.

The dredge stabilization and movement system can have the first external vessel reversibly coupled at one or more attachment points along a first axis adjacent the dredge and a surface of the water. A second external vessel can be reversibly coupled at one or more attachment points along a second axis adjacent the dredge and the surface of the water. In particular, the first axis and the second axis can be oriented transversely, and in a most particular example the first axis can be designated an X-axis and the second axis can be designated a Y-axis. One skilled in the art can select other suitable orientations for the first axis and the second axis within the scope of the present disclosure.

Each of the external vessels can have a propulsion unit that can be configured as a Z-drive type control for maintaining position. The 360-degree rotational capability of the Z-drive type control can be controlled by an external vessel operator. The Z-drive type control can also be autonomously or semi-autonomously controlled by the control module or where the control module includes a central computer system and/or autopilot system. The control module can be located on the dredge or the external vessel or at an off-site location communicating via satellite or a wireless internet connection, as non-limiting examples.

Each of the external vessels can also be equipped with a global positioning system (GPS). The GPS can communicate with the control module and each of the external vessel. The control module can utilize the information transmitted from the GPS to deliver data to a display screen on each of the external vessel. The external vessel operator can then utilize the data to apply adjustments to a graphical user interface on the display screen to conduct movements using the Z-drive type control.

Each of the external vessels can also maintain a position using one or more anchor devices, which can include one or more spuds, where the anchor devices can be used in conjunction with the Z-drive type controls. The spuds can be configured to descend from the dredge until they are embedded into a seafloor. Advantageously, the spuds used in conjunction with the Z-drive type control can militate against an undesirable movement of the dredge. A skilled artisan can select other suitable methods of securing the vessel, as desired.

If the spuds cannot reach the seafloor due to the depth of the seafloor, the external vessels can independently or cooperatively maintain the position of the dredge. Where it is necessary for the dredge to move positions, the GPS can be configured to communicate new coordinates to the control module which can direct the new coordinates to the display screen of one or more external vessels. The external vessel operator can then apply adjustments to the graphical user interface which controls the Z-drive type controls to provide movement of the dredge to the new coordinates. This can be done expeditiously without the use of spuds.

In certain examples, it should be appreciated that the system can be employed without the GPS. In such cases, the real-time positioning of the dredge and the positioning vessel can be accomplished or determined by other suitable means including, but not limited to, the employment of direct wireless communications between the vessel, or the use of transceiver beacons placed around the area where the platform and dredge is being moved. One of ordinary skill in the art can also select other suitable means for determining the real-time positions, as desired.

Advantageously, the dredge stabilization and movement system of the present disclosure efficiently and accurately positions the dredge in deeper waters and where lateral movements may be required.

Further areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described herein.

FIG. 1 is a side elevational view of a marine positioning system, according to an embodiment of the present disclosure, and further showing a floating platform having an anchoring mechanism and an external vessel having a propulsion unit;

FIG. 2 is a top plan view of the marine positioning system shown in FIG. 1, and further showing the marine positioning system having another external vessel having a propulsion unit;

FIG. 3 is a schematic illustration of a marine positioning system, according to another embodiment of the present disclosure, further showing the interaction between a positioning module, a control module, a propulsion unit, and a display module.

FIG. 4 is a flowchart illustrating a method of using a marine positioning system, according to another embodiment of the present disclosure, further showing a step of automatically positioning the floating platform into a preselected position, by the control module, using instructions generated by the control module; and

FIG. 5 is a flowchart illustrating a method of using the marine positioning system, according to another embodiment of the present disclosure, further showing a step of positioning the floating platform into the preselected position, by a user, using the instructions generated by the control module.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed.

The terms “a” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. The term “about” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

All documents, including patents, patent applications, and scientific literature cited in this detailed description are incorporated herein by reference, unless otherwise expressly indicated. Where any conflict or ambiguity can exist between a document incorporated by reference and this detailed description, the present detailed description controls.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

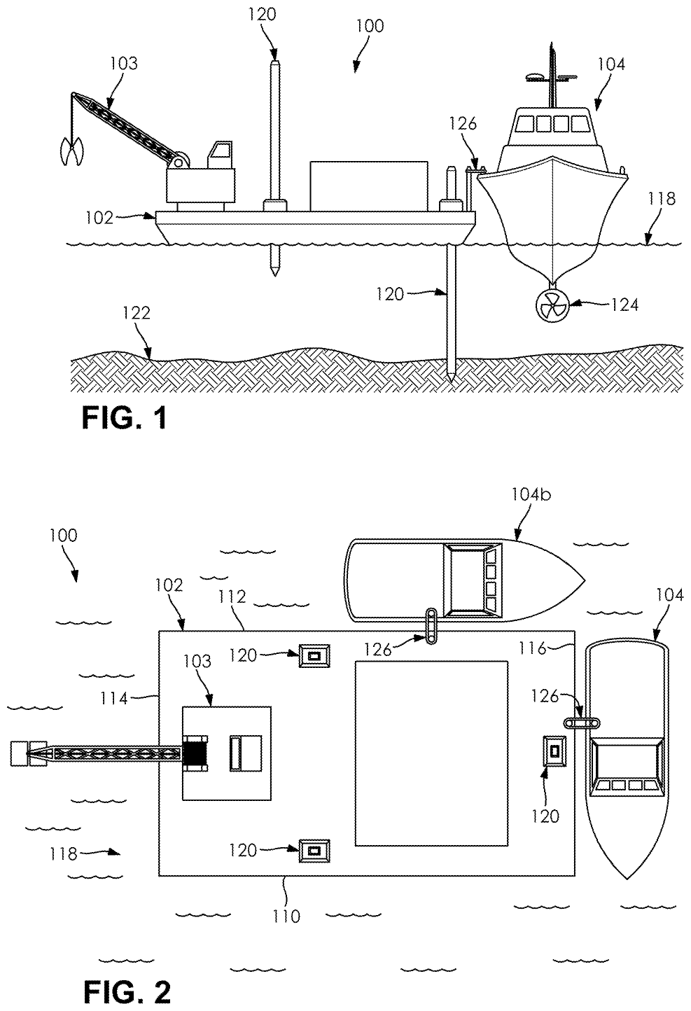

With reference to FIGS. 1-2, a marine positioning system 100 is shown. The marine positioning system 100 can include a floating platform 102, an external vessel 104, a positioning module 106, and a control module 108. The floating platform 102 can include multiple sides, including a port side 110, a starboard side 112, a stern 114, and a bow 116. The floating platform 102 can be configured to function as a floating work platform that can hold different types of equipment. In certain examples, the floating platform 102 can include a dredger 103, which can be used to carry out different objectives, such as relocating submerged material and salvaging. For example, the floating platform 102 can include the carouseling articulated dredge and barge, as disclosed in U.S. Pat. No. 10,167,609 to Cashman et al., the entire disclosure of which is incorporated herein by reference. Other non-limiting examples of equipment can also include a crane and/or the dragging apparatus with ripper shank, as disclosed in U.S. Pat. No. 10,920,400 to Cashman et al., the entire disclosure of which is incorporated herein by reference. However, it should be appreciated that a skilled artisan can select different types of floating work platforms for the floating platform 102, within the scope of this disclosure.

The floating platform 102 can be configured to be positioned in a preselected position in a body of water 118. The preselected position is a location in the body of water 118 that is chosen by the user. For example, the preselected position can be an area where the submerged material is to be relocated or where salvaging will take place. It should be appreciated that preselected position can have a depth, which can vary according to a geography of the surrounding area.

Now referring to FIG. 1, the floating platform 102 can also include one or more anchoring mechanisms 120. The one or more anchoring mechanisms 120 can be selectively deployed to militate against the floating platform 102 drifting from the preselected position during operation or during the natural movement of the body of water 118, for example due to tides, currents, wind, etc. The anchoring mechanism 120 can include anchor lines and spuds. Spuds can be defined as pipes that can be driven into a bottom surface 122 of the body of water 118 below the preselected position. Desirably, the spuds can be used to hold the floating platform 102 into the preselected position. Other non-limiting examples of the anchoring mechanism 120 can also include the anchor driving device, as disclosed in U.S. Pat. No. 10,494,784 to Mannering et al., the entire disclosure of which is incorporated herein by reference. It should be appreciated the one skilled in the art can employ different types of anchoring mechanisms and combinations of different types of anchoring devices, as desired. In addition, it should be appreciated that in some embodiments, the floating platform 102 does not require the anchoring mechanism 120.

In certain examples, the anchoring mechanism 120 can be selectively deployed to function as a pivot point while the floating platform 102 is being moved by the external vessel 104. For example, the anchoring mechanism 120, such as the spud, can be driven into the bottom surface of the body of water 118, as shown in FIG. 1. Then, when the external vessel 104 moves the floating platform 102, the floating platform 102 can rotate about the anchoring mechanism 120 (the pivot point) deployed into the bottom surface of the body of water 118. Desirably, this can permit the anchoring mechanism 120 to assist in rotating and positioning the floating platform 102 during a dredging operation. It should be appreciated that a person skilled in the art can employ the anchoring mechanism 120 using different methods, within the scope of this disclosure.

The external vessel 104 can be reversibly coupled to the floating platform and configured to position the floating platform 102 in the preselected position. In addition, the external vessel 104 can be configured to maintain the floating platform 102 in the preselected position. Advantageously, the external vessel 104 can maintain the floating platform 102 in the preselected position alone, or in combination with the anchoring mechanism 120. Desirably, the external vessel 104 can maintain the position of the floating platform 102, even when the anchoring mechanism 120 could not reach the bottom surface of the body of water 118; e.g., where a length of the spud is less length the depth of the body of water 118. In addition, it is believed using the external vessel 104 to maintain the floating platform 102 can also reduce the overall operation time. For example, the crew would not have to waste time deploying and rescinding one or more anchoring mechanisms 120.

While still referring to FIG. 1, the external vessel 104 can have a propulsion unit 124 configured to propel the floating platform 102 in a preselected direction. Desirably, the propulsion unit 124 can permit for the floating platform 102 to be moved to the preselected location by propelling the floating platform 102 in the preselected direction. The preselected direction can be between 0 and 360 degrees. Advantageously, this can permit the floating platform 102 to be moved in any foreseeable direction while maintaining the external vessel coupled to the floating platform.

In certain embodiments, the propulsion unit 124 can be an azimuth thruster that can be rotated to any angle about a substantially horizontal plane. In certain examples, the propulsion unit 124 can be a Z-drive. Advantageously, the Z-drive can effectively replace a propeller, a shaft, a stern tube, a marine gear, a rudder, and a steering gear all with a single unit. This can eliminate rudder drag. In addition, Z-drives can facilitate parallel parking with the floating platform 102. It should be appreciated that one skilled in the art can employ different types of propulsion technologies for the propulsion unit 124.

With reference to FIGS. 1-2, the external vessel 104 can be reversibly coupled to the floating platform 102 with a fastener 126. Desirably, this can permit the external vessel 104 to move the floating platform 102 when coupled thereto, including towing, or pushing the floating platform 102, and allow the external vessel 104 to be used for other operations when decoupled. The fastener 126 can include various types of couplings, mechanical interlocks, hitches, and/or ropes that permit for the external vessel 104 to move the floating platform 102. It should be appreciated that a skilled artisan can select other methods for coupling the external vessel 104 to the floating platform 102, within the scope of this disclosure.

Referring now to FIG. 2, the marine positioning system 100 can include another external vessel 104b. The another external vessel 104b can have an identical or similar structure and/or function to the external vessel 104. In some configurations, the external vessel 104 and the another external vessel 104b cooperate to position and/or maintain the floating platform 102 in the preselected position. In other configurations, the external vessel 104 and the other external vessel 104b can operate separately to position and/or maintain the floating platform 102 in the preselected position.

In certain configurations, the external vessel 104 and the another external vessel 104b are reversibly coupled to different sides of the floating platform 102, as shown in FIG. 2. For example, the external vessel 104 can be coupled to at least one of the port side 110 and the starboard side 112 of the floating platform 102, while the another external vessel 104b can be coupled to at least one of the bow 116 and the stern 114 of the floating platform 102. It should be appreciated that a skilled artisan can adjust the number of external vessels used in the system, within the scope of this disclosure. For example, if the floating platform 102 is larger than a certain size, more than the two external vessels 104, 104b may be necessary to achieve a desired performance. Similarly, if the floating platform 102 is smaller than a certain size, only a single external vessel 104 or 104b may be necessary to achieve a desired performance.

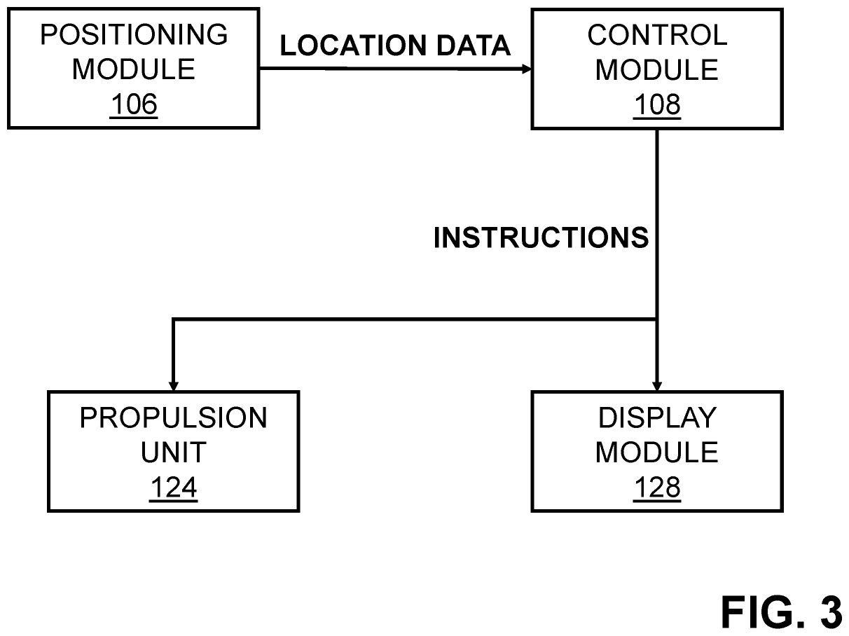

With reference to FIG. 3, the positioning module 106 can be in communication with at least one of the external vessel 104, the other external vessel 104b, and a control module 108. This can be accomplished through wired technology, wireless technology, or other suitable means. The positioning module 106 can be configured to generate the location data of one of the floating platform 102, the external vessel 104, and both the floating platform 102 and the external vessel 104. The location data can include information that can be used to approximate the location of at least one of floating platform 102, the external vessel 104, and both the floating platform 102 and the external vessel 104.

In certain examples, the location data can include geolocation data and time information. The geolocation data and time information can be utilized to approximate the location of at least one of floating platform 102, the external vessel 104, and the another vessel 104b at a given time. A skilled artisan can select other types of data to be included in the location data, as desired. In certain examples, the positioning module 106 can utilize a satellite-based radionavigation system, such as the Global Positioning System (GPS). Desirably, this can permit the location of at least one of floating platform 102, the external vessel 104, and both the floating platform 102 and the external vessel 104 to be determined with sufficient accuracy. It should be appreciated that the positioning module 106 can utilize other technologies to generate the location data of one of the floating platform 102, the external vessel 104, and both the floating platform 102 and the external vessel 104. Non-limiting examples can include radar, lidar, and sonar.

While still referring to FIG. 3, the control module 108 can be in communication with the propulsion unit 124 and the positioning module 106. This can be accomplished through wired technology, wireless technology, or other suitable means. The control module 108 can be configured to receive the location data from the positioning module 106. In some instances, the control module 108 can be continuously receiving the location data from the positioning module 106. In other instances, the control module 108 can receive the location data from the positioning module 106 at a predetermined interval. The predetermined interval can be scaled according to how often the floating platform 102 is drifting from the preselected position. For example, if the floating platform 102 is up against a current, the positioning module 106 can transmit the module at a shorter interval to update the approximated location of the floating platform 102.

The control module 108 can also be configured to determine an extrapolated position of floating platform 102 by comparing the approximated position of at least one of the external vessel 104 and the another external vessel 104b with a spatial relationship. The spatial relationship can be the position of at least one of the external vessel 104 and the another external vessel 104b; e.g., which side of the floating platform 102 that each of the external vessel 104 and the external vessel 104b is reversibly coupled to. In certain examples, the user provides the spatial relationship by inputting the spatial relationship into the control module 108. This can also include the user inputting the dimensions of the floating platform 102 to the control module 108. In other examples, the control module 108 generates the spatial relationship by comparing the location data of the external vessel 104 and the another external vessel 104b.

The control module 108 can be also be configured to determine if the floating platform 102 is in the preselected position by comparing the location data with the preselected position. In certain examples the control module 108 determines if the floating platform 102 is in the preselected position by comparing the extrapolated position of the floating platform 102 with the preselected position. The control module 108 can be further configured to generate instructions based on these comparisons. The instructions can include the distance and angle between the approximated location and the preselected position. In certain examples, instructions can include the preselected direction that the floating platform 102 needs to travel to be positioned in the preselected position. This can allow the instructions generated by the control module 108 to be used to initially position the floating platform 102 in the preselected position. Desirably, this can also allow the instructions to be used to maintain the floating platform 102 in the preselected position. This can be particularly useful in situations where the depth of the body of water 118 is greater than what the anchoring mechanism 120 can handle (e.g., when a spud is shorter than the depth of the body of water 118). It should be appreciated that the instructions generated by the control module 108 can include additional information that can be used to direct the floating platform 102 to the preselected location, including for example adjustments for tide, current, wind, etc.

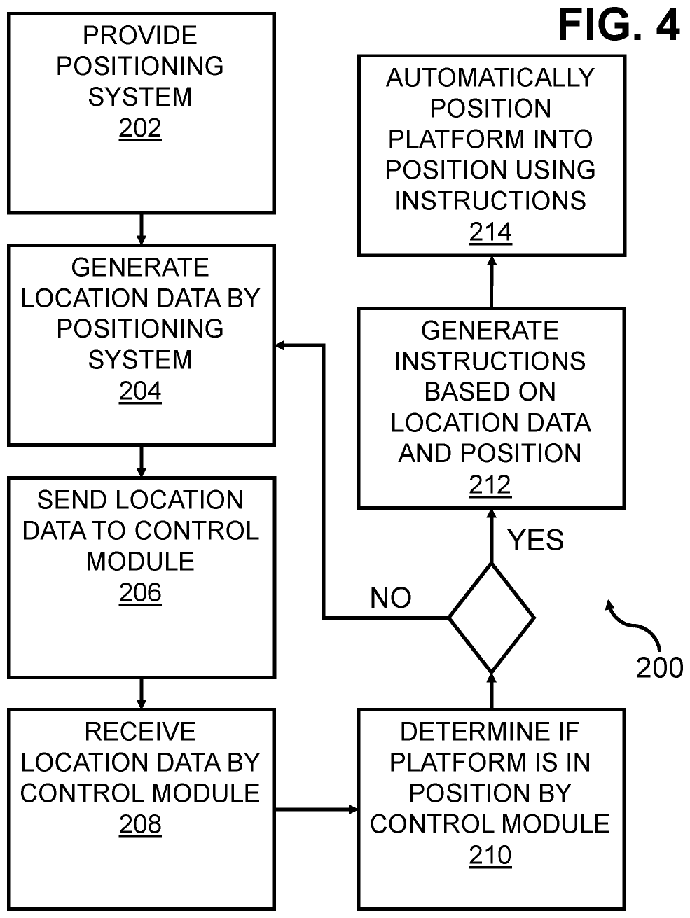

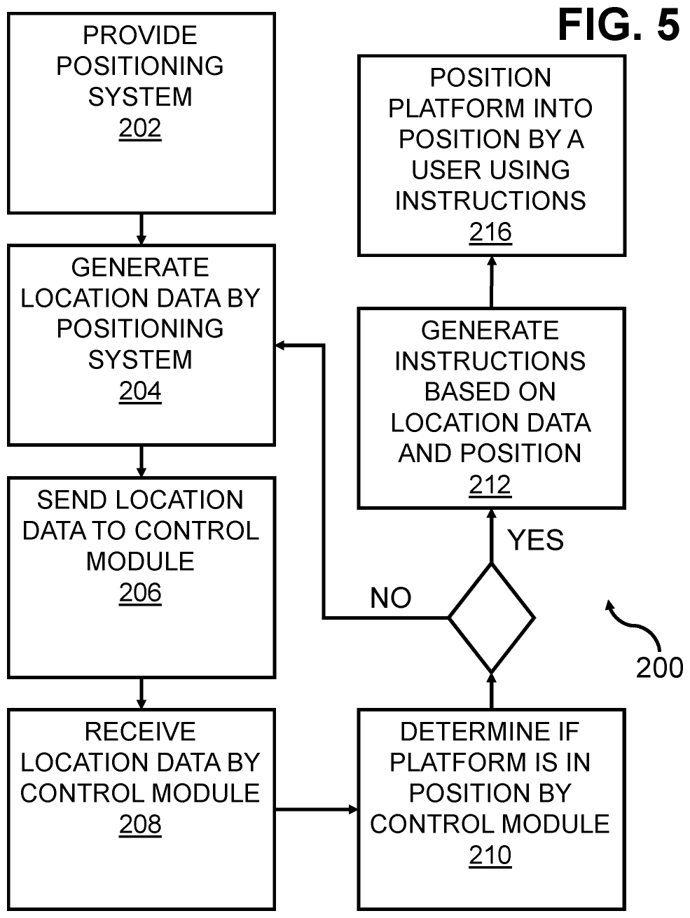

In certain examples, the instructions generated by the control module 108 can automatically engage the propulsion unit 124 to propel the floating platform 102 in the preselected direction to position the floating platform 102 in the preselected position, as shown in FIGS. 3-4. For example, the control module 108 can act as an autopilot and directly operate the propulsion unit 124 to position the floating platform 102 into the preselected position. Advantageously, this can permit the control module 108 to automatically position and/or maintain the floating platform 102 in the preselected position by moving the floating platform 102 in the preselected direction. In other examples, a user operates the propulsion unit 124 using the instructions generated by the control module 108 to propel the floating platform 102 in the preselected direction to position the floating platform 102 in the preselected position or maintain the floating platform 102 in the preselected position, as shown in FIGS. 3 and 5. This can be useful when automating control of the propulsion unit 124 is not limited to a given application.

The control module 108 can be located on at least one of the floating platform 102, external vessel 104, and the other external vessel 104b. However, in certain examples the control module 108 can be located remotely from the floating platform 102, external vessel 104, and the other external vessel 104b. The control module 108 can have a processor and memory. The memory can include a tangible, non-transitory computer readable medium with processor-executable instructions stored thereon. In certain examples, the control module 108 can transmit the instructions to a software platform having a graphical user interface (GUI). Desirably, this can permit the user to view and interact with the instructions generated by the control module 108. For example, at least one of the floating platform 102, the external vessel 104, and the other external vessel 104b can have a display module 128. The display module 128 can be configured to display the GUI with the instructions generated from control module 108.

It should be appreciated that the positioning module 106 and the control module 108 can be combined with one or more modules to accomplish the same or similar functions, within the scope of this disclosure.

With reference to FIGS. 3-4, a method 200 of using the marine positioning system is shown at 200. The method 200 having a step 202 of providing the marine positioning system 100. In a step 204, the positioning module 106 determines the location data of one of the floating platform 102, the external vessel 104, and both the floating platform 102 and the external vessel 104. It should be appreciated that this can include the location data of the another external vessel 104b. The positioning module 106 can send the location data to the control module 108, in a step 206. In a step 208, the control module 108 can receive the location data. In a step 210, the control module 108 can determine if the floating platform 102 is in the preselected position by comparing the preselected position with the location data. If the control module 108 determines the floating platform 102 is in the preselected position, then the control module 108 waits to receive a subsequent transmission from the positioning module 106. If the control module 108 determines the floating platform 102 is not in the preselected position, then the control module 108 generates the instructions, in a step 212. As mentioned previously, the instructions can include the preselected direction that the floating platform 102 needs to travel to be positioned in the preselected position.

Now referring to FIG. 3, the method 200 can include a step 214 of the control module 108 automatically positioning the floating platform 102 into the preselected position by using the instructions generated by the control module 108. Desirably, this permits for the floating platform 102 to be moved to the preselected position and/or maintained in the preselected position automatically.

With reference to FIG. 5, the method 200 can include a step 216 of the user positioning the floating platform 102 into the preselected position by using the instructions generated by the control module 108. This can permit the floating platform 102 to be moved to the preselected position when in situations where automation would need not be applicable.

Advantageously, the marine positioning system 100 and the method 200 can position the floating platform 102 in waters that are too deep for traditional anchoring mechanisms. In addition, the marine positioning system 100 and method 200 can be used to actively maintain the floating platform 102 in the preselected position by using the control module 108.

While certain representative embodiments and details have been shown for purposes of illustrating the invention, it will be apparent to those skilled in the art that various changes can be made without departing from the scope of the disclosure, which is further described in the following appended claims.

What is claimed is:

1. A marine positioning system, comprising:
a floating platform;
an external vessel reversibly coupled to the floating platform and configured to position the floating platform in a preselected position, the external vessel having a propulsion unit configured to propel the floating platform in a preselected direction between 0 and 360 degrees;
a positioning module configured to generate location data of one of the floating platform, the external vessel, and both the floating platform and the external vessel; and
a control module in communication with the propulsion unit and the positioning module, the control module configured to receive the location data from the positioning module, determine if the floating platform is in the preselected position, and generate instructions including the preselected direction that the floating platform needs to travel to be positioned in the preselected position.

2. The marine positioning system of claim 1, wherein the floating platform includes a dredge.

3. The marine positioning system of claim 1, wherein the propulsion unit includes an azimuth thruster.

4. The marine positioning system of claim 1, wherein the floating platform includes an anchoring mechanism.

5. The marine positioning system of claim 4, wherein the anchoring mechanism is selectively deployable to function as a pivot point while the floating platform is being moved by the external vessel.

6. The marine positioning system of claim 1, wherein the positioning module includes a satellite-based radionavigation system.

7. The marine positioning system of claim 1, wherein the instructions generated by the control module include instructions to actively maintain the floating platform in the preselected position by controlling the propulsion unit of the external vessel.

8. The marine positioning system of claim 7, wherein the control module maintains the floating platform in the preselected position by comparing the location data received by the positioning module with the preselected position.

9. The marine positioning system of claim 8, wherein the control module receives the location data at a predetermined interval from the positioning module.

10. The marine positioning system of claim 1, wherein the instructions generated by the control module include automatically engaging the propulsion unit to propel the floating platform in the preselected direction to position the floating platform in the preselected position.

11. The marine positioning system of claim 1, wherein a user operates the propulsion unit using the instructions generated by the control module to propel the floating platform in the preselected direction to position the floating platform in the preselected position.

12. The marine positioning system of claim 1, wherein the control module is located remotely from the floating platform and the external vessel.

13. The marine positioning system of claim 1, further comprising another external vessel reversibly coupled to the floating platform and configured to position the floating platform in the preselected position, the another external vessel having a propulsion unit configured to propel the floating platform and the another external vessel in a preselected direction between 0 and 360 degrees.

14. The marine positioning system of claim 13, wherein the external vessel and the another external vessel cooperate to selectively position and maintain the floating platform in the preselected position.

15. The marine positioning system of claim 13, wherein the external vessel and the another external vessel are each reversibly coupled to different sides of the floating platform.

16. The marine positioning system of claim 1, wherein at least one of the floating platform and external vessel has a display module configured to display the instructions from the control module.

17. A marine positioning system, comprising:
a floating platform including a dredge;
a plurality of external vessels, each external vessel reversibly coupled to the floating platform and configured to position the floating platform in a preselected position, each external vessel having a propulsion unit configured to propel the floating platform in a preselected direction between 0 and 360 degrees;
a positioning module configured to generate location data of one of the floating platform, one of the external vessels, and both the floating platform and one of the external vessels, the positioning module including a satellite-based radionavigation;
a control module in communication with the propulsion unit and the positioning module, the control module configured to receive the location data from the positioning module, determine if the floating platform is in the preselected position, and generate instructions including the preselected direction that the floating platform needs to travel to be positioned in the preselected position; and
an anchoring mechanism.

18. A method using a marine positioning system, comprising:
providing the marine positioning system including:
a floating platform;
an external vessel reversibly coupled to the floating platform and configured to position the floating platform in a preselected position, the external vessel having a propulsion unit configured to propel the floating platform in a preselected direction between 0 and 360 degrees;
a positioning module configured to generate location data of one of the floating platform, the external vessel, and both the floating platform and the external vessel; and
a control module in communication with the propulsion unit and the positioning module, the control module configured to receive the location data from the positioning module, determine if the floating platform is in the preselected position, and generate instructions including the preselected direction that the floating platform needs to travel to be positioned in the preselected position;
generating, by the positioning module, the location data of one of the floating platform, external vessel, and both the floating platform and the external vessel;
sending, by the positioning module, the location data to the control module;
receiving, by the control module, the location data;
determining, by the control module, if the floating platform is in the preselected position by comparing the preselected position with the location data; and
generating instructions, by the control module, the instructions including the preselected direction that the floating platform needs to travel to be positioned in the preselected position.

19. The method of claim 18, further including a step of automatically positioning the floating platform into the preselected position, by the control module, using the instructions generated by the control module and operating the propulsion unit.

20. The method of claim 18, further including a step of positioning the floating platform into the preselected position, by a user, using the instructions generated by the control module and operating the propulsion unit.
